(19) United States
(12) Patent Application Publication
(10) Pub. No.: US 2013/0243577 A1
(43) Pub. Date: Sep. 19, 2013

(54) MONITORING OF CLEARANCE

(71) Applicants: Kamaljit Singh Chana, Malvern (GB); Jonathan Shamus Sullivan, Malvern (GB)

(72) Inventors: Kamaljit Singh Chana, Malvern (GB); Jonathan Shamus Sullivan, Malvern (GB)

(73) Assignee: QINETIQ LIMITED, Farnborough, Hampshire (GB)

(21) Appl. No.: 13/989,077

(22) PCT Filed: Dec. 9, 2011
(86) PCT No.: PCT/GB2011/001702

§ 371 Date: May 23, 2013

(30) Foreign Application Priority Data
Dec. 14, 2010 (GB) 1021179.5

(51) Int. Cl. G01B 7/14

(52) U.S. Cl. CPC G01B 7/14
USPC 415/118; 324/207.13

(57) ABSTRACT

The clearance between a stationary object (such as a gas turbine engine casing) and one or more moving objects (such as the blades of a rotating turbine) is measured using a pair of electrical proximity sensors mounted on the stationary object with their sensitive fields directed towards the path of the moving object(s) and at angle to each other. The clearance is calculated by deriving a time interval between interceptions of the respective moving object with the sensitive fields of the two sensors and from the geometry of the set up.

The present invention relates to the use of electrical proximity sensors for monitoring the clearance between moving and stationary parts. More particularly it is concerned with monitoring the clearance between rotor blade tips and a surrounding casing in turbomachinery and even more particularly in relation to the blades of fans, compressors and turbines in gas turbine engines. In principle, however, the invention is applicable to monitoring the clearance of a wide variety of moving parts such as rotors, gears and racks in machines of many kinds and whether rotary or linear in motion. The invention will be more particularly described in terms of the use of eddy current sensors for this service although again it may employ electrical proximity sensors of various different types, including capacitive sensors and those based on the detection of electrical permittivity or magnetic susceptibility.

In the case of a gas turbine engine it is known that tip leakage flow around the turbine blades has a direct impact on turbine efficiency and therefore on overall engine efficiency. Maintaining a consistent maximum tip to casing clearance to minimise such leakage flow across the whole engine operational envelope and during transients is difficult and, to ensure that the blades do not come into contact with the casing, conservative nominal clearances are generally used. To increase the efficiency of such engines it has been proposed to deploy active tip to casing clearance control, where thermal growth of the casing is controlled using cooling flows to maintain a desirably small clearance with the blade tips. To implement such a system the distance between the blade tips and casing therefore needs to be know accurately at all times.

A preferred form of eddy current sensor for use in monitoring blade tip timing and clearance in turbomachinery is known from WO2009/004319. It comprises a device which can be mounted through or behind a turbine casing and has a common coil for use in both generating a magnetic field in a region inside the casing and detecting the effect of eddy currents generated by that field in the blade tips passing through that region. To increase the resolution of the device the coil is wound on a former of rectangular or otherwise elongate section and is mounted with the direction of the shorter cross-sectional dimension of the coil aligned with the shorter cross-sectional dimension (i.e. thickness direction) of the passing blade tips. In use the coil is driven by a constant alternating current to generate the magnetic field and the secondary magnetic fields which are generated by the eddy currents induced in the passing blade tips cause the inductive reactance of the coil to change. By monitoring its voltage an output signal can be derived comprising a series of waves, each representing the passage past the sensor of a respective blade tip. Timing information can be extracted from this signal by selecting consistent “trigger” points on each wave to represent a time of arrival of each blade and the peak amplitude of each wave can be taken as an indication of the clearance distance of the respective blade tip from the casing.

The peak amplitudes of the waves derived from such a sensor are, however, also influenced by changes in temperature of the sensor and of the turbine blades which change the resistances of the sensor coil and of the blade materials and lead to errors in the measurement of blade tip to casing clearances when relying on the value of the peak amplitudes for this measurement. It is generally feasible to apply a correction for changes in sensor temperature but in order to adequately correct for changes in blade temperature it is necessary to measure that temperature accurately in real time over the whole operational envelope of the engine (and which can typically reach in the region of 1500° C.) which presents a significant technical challenge.

It is therefore a particular aim of the present invention to provide a method for accurately monitoring the turbine blade tip to casing clearance in a gas turbine engine irrespective of changes of temperature and in one aspect the invention is predicated on the realisation that while the wave peak amplitudes derived from the known eddy current sensor are influenced by changes of temperature the accuracy of the timing information which can be extracted need not be.

In one aspect the invention accordingly resides in apparatus for use in monitoring the clearance between a stationary object and one or more moving objects comprising a pair of electrical proximity sensors mounted in relation to the stationary object with their sensitive fields directed towards the path of the moving objects and at an angle to each other. In use of such apparatus the clearance between the stationary and moving objects can be derived from the geometry of the set up and a time interval between interceptions of the respective moving objects with the sensitive fields of the proximity sensors and it will be appreciated that, for any given speed of the moving object, in the case of convergent fields that time interval will decrease with increasing clearance between the objects and in the case of divergent fields that time interval will increase with increasing clearance between the objects.

In another aspect the invention accordingly resides in a method of monitoring the clearance between a stationary object and one or more moving objects which comprises operating the proximity sensors in an apparatus as defined above and deriving a time interval between interceptions of the respective moving object with the sensitive fields of the proximity sensors.

These and other aspects and features of the present invention will now be more particularly described, by way of example, with reference to the accompanying schematic drawings in which:

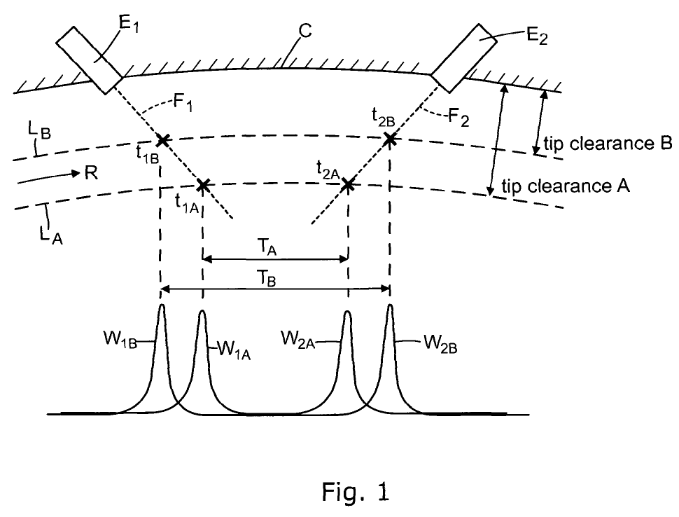

FIG. 1 illustrates one preferred geometry of apparatus according to the invention;

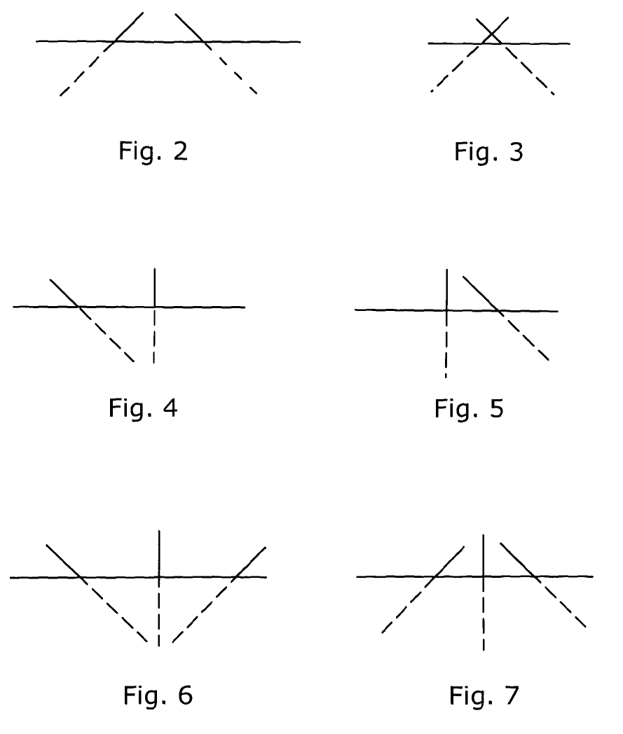

FIGS. 2 to 7 illustrate alternative geometries; and

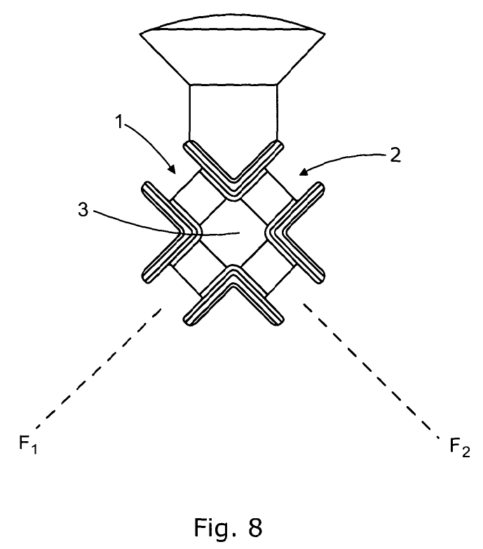

FIG. 8 illustrates an integrated former for sensor coils in an arrangement according to FIG. 3.

Referring to FIG. 1 there is illustrated schematically one embodiment of apparatus according to the invention set up to monitor the clearance between the turbine blade tips and the surrounding casing of a gas turbine engine. The casing is indicated at C and the loci of the tip of a rotating blade at two exemplary clearances A and B are indicated by the dotted lines L_{A} and L_{B}, it being noted that the blade tip to casing clearance distance may vary to a substantial extent across the engine's operational envelope due to differential thermal expansion of the blades and casing, unless the latter is controlled. Two eddy current sensors E₁ and E₂ are mounted to the casing C at oblique angles. They are preferably of the form described in WO2009/004319 each comprising a common coil for use in both generating a magnetic field and detecting the effect of eddy currents generated by that field in the passing blade tips. The central axes of the generated fields are nominally indicated by the dotted lines F₁ and F₂ and are seen to extend inwards of the casing C and, by virtue of the angled mounting of the sensors, to converge towards each other with an included angle of approximately 85°, although in other embodiments angles in the range of 15-90° may be used. The coils of the sensors are preferably wound on formers of rectangular or otherwise elongate section and mounted with the shorter cross-sectional dimension of the coil aligned with the shorter cross-sectional dimension (i.e. thickness direction) of the passing blade tips.

In use, the coil of each sensor E₁, E₂ is driven by an alternating current to generate an alternating magnetic field around the coil and extending forwards of the device as nominally indicated by the axes F₁, F₂. For use with gas turbines where the blade passing frequency is typically in the order of 10 KHz the coils will be driven at a frequency in the order of 1 MH_{z}. They may be driven at the same frequency although to avoid cross-talk between the sensors they are preferably driven at two different frequencies. As the respective electrically conductive blade tips pass through the respective magnetic fields (in the direction of the arrow R) eddy currents are induced in the surface of each tip. These eddy currents in turn generate a secondary magnetic field inducing a secondary voltage in the respective sensor coil. This causes the coil's inductive reactance to change, the interaction between the coil and blade tip in this respect being akin to that between the windings of a loosely coupled transformer. The respective coil is driven at constant current and its voltage is monitored from which an output signal is derived comprising a series of waves, each representing the passage past the respective sensor of a respective blade tip. In FIG. 1 a pair of waves W_{1A} and W_{2A} are notionally indicated representing the passage past the pair of sensors E₁ and E₂ of a blade tip at clearance A and a pair of waves W_{1B} and W_{2B} are notionally indicated representing the passage past the pair of sensors E₁ and E₂ of a blade tip at clearance B, it being appreciated that for a given speed of rotation the temporal spacing between the waves W_{1A} and W_{2A} is less than that between the waves W_{1B} and W_{2B} due to the convergent relationship between the two sensor fields.

As there is a geometrical relationship in the arrangement of FIG. 1 between the tip clearance distance, the projected angles of the two sensitive fields, and the points of interception of a blade tip at that clearance with those fields, it follows that the tip clearance can be derived if the distance between those interceptions can be derived or in other words, for a given rotational speed, if the time interval between those interceptions can be derived. Timing information is therefore extracted from the waveforms such as those exemplified by W_{1A}, W_{2A} and W_{1B}, W_{2B}. For accurate timing extraction it is necessary to select a consistent position on each wave to act as the “trigger” point to define a time of interception. For ease of illustration in FIG. 1 the “trigger” points on each pair of waves are taken as the positions of the peak amplitudes, which are assumed to occur when the blade tip intercepts the axis F₁ or F₂ of the respective sensor field. That is to say in the example of tip clearance A the interval T_{A} is taken between the times corresponding to the interception points t_{1A}, and t_{2A} and in the example of tip clearance B the interval T_{B} is taken between the times corresponding to the interception points t_{1B} and t_{2B}. Some other correlating feature of each wave may be selected as the respective “trigger” point for this purpose, however. For example for the reasons discussed in WO2009/004319 it may be preferable to select as “trigger” points the position on the rising or falling edge of the respective wave that corresponds to a selected fractional amplitude between the respective peak amplitude and the preceding or succeeding trough amplitude.

To derive the spatial intervals between the respective interception points from the time intervals such as T_{A} or T_{B} it is also necessary to know the prevailing rotational speed of the turbine, which may for example be derived from a conventional “once per revolution” sensor.

In an alternative embodiment, however, a correlation technique can be applied to the waves derived from successive blade passings which avoids the need to derive a separate measure of speed.

It is noted that in the arrangement of FIG. 1 with a blade tip approaching the field of sensor E₂ from the left as viewed, due to the angle of that field it will be intercepted by the flank of the blade before the tip of the blade. It has been found, however, that the output of such a sensor is more strongly influenced by eddy currents generated in the tip surface than in the flank surface so this factor does not significantly affect the timing information that can be extracted in relation to the position of the tip.

It is also of note that while the peak amplitudes of the waves derived from sensors such as E₁ and E₂ will vary with changes of temperature their temporal positions and the overall form of the waves are generally consistent across the range of temperatures typically experienced so that the derivation of clearance information from timing information as described is substantially independent of blade and sensor temperature.

FIGS. 2 to 7 illustrate alternative geometries for the sensor set up in an apparatus according to the invention but where tip clearance information can be derived from timing information in accordance with the same principles as described with reference to FIG. 1. For ease of illustration in these Figures the curvature of the casing is ignored and only the axes of the sensors are depicted.

FIG. 2 illustrates an embodiment with two sensors at oblique angles to the casing and where the sensitive fields diverge from each other.

FIG. 3 illustrates an embodiment similar to FIG. 2 but where, to minimise disruption to the casing, the two sensors occupy substantially the same circumferential position and cross over each other as viewed parallel to the rotor axis.

FIG. 4 illustrates an embodiment with one sensor directed radially and the other at an oblique angle to the casing and where the sensitive fields converge towards each other.

FIG. 5 illustrates an embodiment with one sensor directed radially and the other at an oblique angle to the casing and where the sensitive fields diverge from each other.

FIGS. 6 and 7 illustrate embodiments comprising three sensors where the central sensor is directed radially and the other two are at oblique angles to the casing and converge (FIG. 6) or diverge (FIG. 7). With these embodiments two time intervals can be taken for each blade passage and a separate measure of speed is unnecessary.

FIG. 8 illustrates one form of an integrated former for winding the coils of two sensors in an arrangement according to FIG. 3. In this embodiment each former 1 and 2 is of an elongate “racetrack” section as viewed along the respective field axis F₁, F₂ and their surfaces intersect centrally as at 3. The two coils may be wound in alternate layers on these formers, thus overlying each other alternately in the regions 3. In the illustrated embodiment the formers intersect at 90° although in other embodiments they may do so at a different angle.

1. Apparatus for use in monitoring the clearance between a stationary object and one or more moving objects comprising a pair of electrical proximity sensors mounted in relation to the stationary object with their sensitive fields directed towards the path of the moving object(s) and at an angle to each other.

2. Apparatus according to claim 1 wherein said angle is within the range of 15-90°.

3. Apparatus according to claim 1 wherein said fields converge towards each other.

4. Apparatus according to claim 1 wherein said fields diverge from each other.

5. Apparatus according to claim 1 wherein said sensors are eddy current sensors.

6. Apparatus according to claim 5 wherein each said sensor comprises a common coil for use in both generating a magnetic field and detecting the effect of eddy currents generated by said field in such moving object(s).

7. Apparatus according to claim 6 further comprising one or more oscillators for applying alternating currents to each said coil at different frequencies to each other.

8. Apparatus according to claim 5 wherein said coils are wound on intersecting formers.

9. (canceled)

10. A turbomachine equipped with apparatus according to claim 1 for use in monitoring the clearance between rotor blade tips and a surrounding casing.

11. A gas turbine engine equipped with apparatus according to claim 1 for use in monitoring the clearance between turbine blade tips and a surrounding casing.

12. A method of monitoring the clearance between a stationary object and one or more moving objects which comprises operating the proximity sensors in an apparatus according to claim 1 and deriving a time interval between interceptions of the respective moving object with the sensitive fields of the proximity sensors.

13. (canceled)

14. The use of a method according to claim 12 for monitoring turbomachinery blade tip clearance.

15. The use of method according to claim 12 for monitoring turbine bade tip clearance in a gas turbine engine.

16. (canceled)
